(19) United States
(12) Patent Application Publication
(10) Pub. No.: US 2018/0052427 A1
(43) Pub. Date: Feb. 22, 2018

(54) Watch Winder and Method of Winding a Watch

(71) Applicant: Vayl Technologies, Newport Beach, CA (US)

(72) Inventors: Yuliy Lieb, Newport Beach, CA (US); Vasiliy Borozdin, Costa Mesa, CA (US)

(21) Appl. No.: 15/653,045

(22) Filed: Jul. 18, 2017

Related U.S. Application Data
(60) Provisional application No. 62/373,865, filed on Aug. 11, 2016.

(51) Int. Cl. G04C 1/04

(52) U.S. Cl. CPC G04C 1/04

(57) ABSTRACT

A watch winder fully winds the watch main spring of various brands of automatic watches, avoiding wear and tear caused by excessive winding caused by prior art winders. In contrast with prior art watch winders, which wind watch main springs a predetermined number of turns, the inventive watch winder precisely detects a fully winded condition of the watch main spring, and stops winding. Prior art watch winders lack that sensing feature, so they continue winding fully winded watches until the predetermined number of turns has been completed. Additionally, the inventive watch winder eliminates the need to guess the number of turns and direction of rotation for different watches. The inventive subject matter further includes methods, which employ deviations in rotation speed to determine watch main spring winding states, such as under-winded, mid-winded, and fully-winded.

This application claims the benefit of priority to U.S. Provisional Application No. 62/373,865 filed Aug. 11, 2016. All extrinsic materials identified herein are incorporated by reference in their entirety.

### FIELD OF THE INVENTION

The field of the invention is winding apparatuses and method for keeping self-winding automatic mechanical watches winded during periods of no use.

### BACKGROUND

The following background discussion includes information that may be useful in understanding the present invention. It is not an admission that any of the information provided herein is prior art or relevant to the presently claimed invention, or that any publication specifically or implicitly referenced is prior art.

Automatic mechanical watches employ spring mechanism for storing energy for watch movement. When not in use, winding of the spring is commonly performed by automatic watch winders. Usually, those machines periodically wind automatic watches for pre-determined number of revolutions with pre-determined direction of rotation. No feedback on the actual winding state of the watch main spring is utilized for prior art watch winders, resulting in under winding, or excessive wear and tear due to unnecessary winding when main spring is already fully winded. The first results in stopped watch, whereas the latter causes mechanical tear of precise gear train of expensive watch, specifically slipping clutch of the watch.

The underlying idea of the present invention is based on the fact that automatic watch main spring cannot accumulate any more mechanical tension in fully winded state. With winding still in-progress for already winded main spring, the excessive mechanical energy dissipates in the form of small pulses generated by mechanical watch gear train, specifically by slipping mechanism. The pulses result in small variations of rotation speed of the winding apparatus rotating shaft. If a sensor capable to detect those variations of speed is employed, then a method of computation could be found for accurate detection of automatic watch winded state. Once number of revolutions needed for full winding is established, a winding schedule could be computed so to keep automatic watch winded when not in use for long period of time, and to avoid wear and tear of the watch mechanism.

Automatic watch winders have been broadly used for decades. They allow to keep automatic mechanical watches running during periods of no use, and also carry out another function: for exhibition purposes. For those familiar with the art, numerous efforts succeeded for ornamental design of the watch winder case, for improving visibility and arrangement of watches, for development multi case and stackable configurations, for development special planetary motion for attached watches, for various designs of the watch mounting holder, for ease of control, for improving programming of the winder, for wireless power and control, for solar energy powered winders, etc. Nevertheless, the previous art does not allow determination of the winded state of the watch main spring, and no sensing means claimed.

Another important prior art apparatus and method (U.S. Pat. No. 7,198,401 B2) claims watch winder and method for keeping automatic watch in optimal partially winded state, so to avoid mechanical wear of watch mechanism. The method claimed under U.S. Pat. No. 7,198,401 B2 describes manual operations, involving series of tests followed by manual calculations, for determination of winding schedule for automatic watch, so to avoid wear and tear. The apparatus claimed under U.S. Pat. No. 7,198,401 B2 does not employ any sensor for determination state of winding of the watch main spring. Instead, the U.S. Pat. No. 7,198,401 B2 claimed method assumes indirect way for that determination: with testing by a person. The user of the watch winder has to manually perform series of tests for determination number of revolutions, for manual calculation of number of revolutions needed for partial winding, for setting up winding schedule, and periodically make corrections. As a result, operation of the prior art watch winder within optimal partially winded automatic watch main spring state involves significant effort input by the user, and does not guarantee accuracy.

Another shortcoming of the previous art is mechanical noise caused by friction, gears, and motor. Significant progress reported on lowering level of noise, but it was never eliminated completely.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### SUMMARY OF THE INVENTION

The objective of present invention is a winding apparatus and method for automatic mechanical watches. The apparatus and method of this invention overcome some deficiencies of the prior art. The apparatus and method of this invention can detect watch main spring state during winding process, detect under winded and fully winded state of the spring, automatically find direction of rotation for winding, completely eliminates operational noise.

To accomplish the abovementioned goals, the winding apparatus and method of the present invention consist of: a rotating shaft carrying automatic watch, angular speed sensor, drive motor; precise angular speed sensor mounted on the above mentioned shaft for determination winding speed rotation and small deviations of the same; contactless, zero noise electric motor rotating the shaft and attached watch to be winded; electronic circuits for interfacing to the angular speed sensor, microcomputer interface, and motor control; microcomputer with user interface for inputting data from the angular speed sensor, and computing control signals for the electric motor; microcomputer programmed constant rotational speed algorithm for maintaining constant average speed during whole winding process; microcomputer programmed present invention method for determination correct direction of watch rotation for winding; microcomputer programmed present invention method for computation winding state of the watch main spring.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 Overall view of the preferred embodiment of the watch winder apparatus.

FIG. 2. Sectional view of mechanical unit of the present invention.

FIG. 3. Sectional view of the electric motor of the present invention.

FIG. 4. Sectional view of electronics unit of the present winding apparatus.

FIG. 5. Block diagram of operation of the present winding apparatus.

FIG. 6. Block diagram of constant winding speed PID (Proportional Integral Differential) algorithm.

FIG. 7. Block diagram of the present invention method for detection watch main spring fully winded state.

FIG. 8. Block diagram of the present method for determination direction of rotation for winding.

FIGS. 9A-C. Present winding apparatus typical results of operation raw data (A), along with present invention method data processing results (B) and (C), in graphical form.

### DETAILED DESCRIPTION

Automatic watch main spring winding mechanism is known to involve numerous designs for transfer swinging rotation of the winding weight (rotor) into main spring tension, thus allowing mechanical energy accumulation within the main spring for watch movement. With fully winded main spring and continuing winding, that energy is partially released thanks to known safety mechanisms such as, for example, slipping clutch. Once the main spring is fully winded, the safety mechanism goes into action, causing mechanical feedback not present during normal winding process. As a result, the watch mechanism receives a series of small mechanical pulses. The present embodiment apparatus allows sensing of those small pulses, whereas method implemented with microcomputer software, allows determination of the main spring winding state.

The above mentioned small pulses result in small variations in rotational speed of the watch winder shaft, whereas average rotation speed of the shaft with attached watch is maintained constant, so those small variations could be detected by the angular speed sensor. Preferred embodiment of the present invention employs high quality ball bearings, although for those experienced in the art, other types of bearings could serve the same or better: air bearings, liquid bearings, magnetic bearings, etc. Preferred embodiment of the present invention employs frictionless Eddy Current electric motor, known for constant torque developed by the motor, and smoothness of rotation, although for those experienced in the art, other drive types can work the same or better: air, liquid, thermal, etc. Another advantage of Eddy Current motor is simplicity for control with conventional electronic circuits.

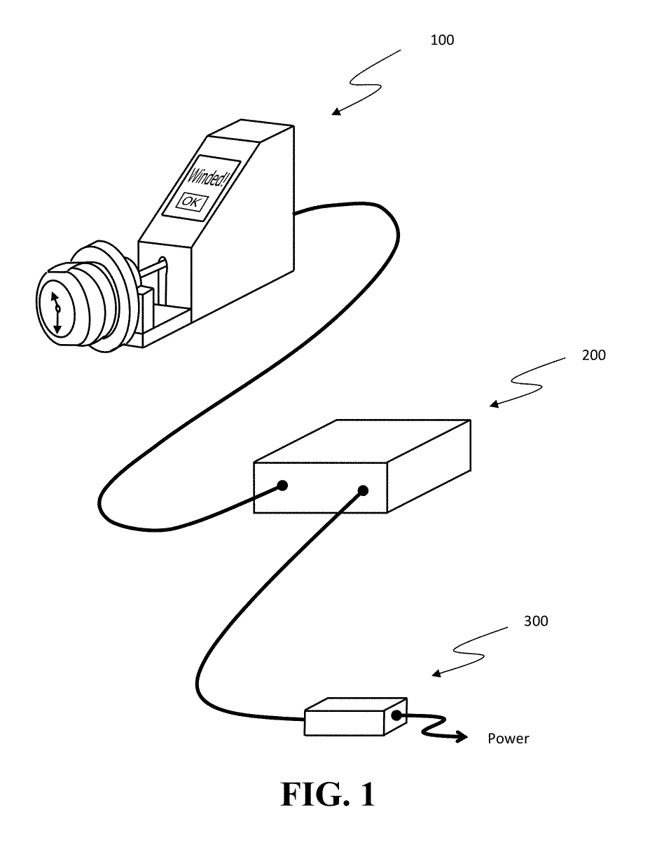

Referring to FIG. 1, preferred embodiment of the present watch winding apparatus consists of three blocks: mechanical unit 100, electronics unit 200, and power supply unit 300. The present embodiment isn't limited to configuration shown. For those skilled in the art, a compact size embodiment could be developed as well, incorporating the same above mentioned features with one single housing.

Mechanical unit 100 carries rotating parts and microcomputer with user interface, whereas electronics unit 200 houses motor control and interface circuits. The power supply unit 300 was chosen one of conventional type.

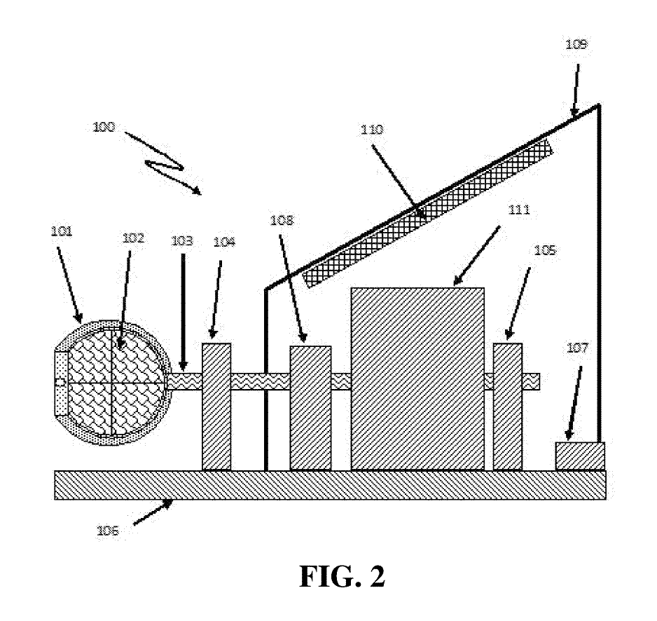

FIG. 2 shows sectional view of mechanical unit of the present invention. Automatic watch 101 mounted to rotating shaft 103 by means of watch holder 102. The shaft 103 of the winding apparatus 100 rests with two precision ball bearings mounted with the means of support stands 104 (front) and 105 (back). The ball bearings precisely aligned, so to avoid any friction above their ratings. Structural support is provided with pedestal 106. Eddy Current motor 111 develops rotational torque, whereas precise angular speed sensor 108 detects speed of rotation. The housing 109 supports microcomputer 110 with user interface. Electrical connector 107 provides power and interfacing to electronics unit 200.

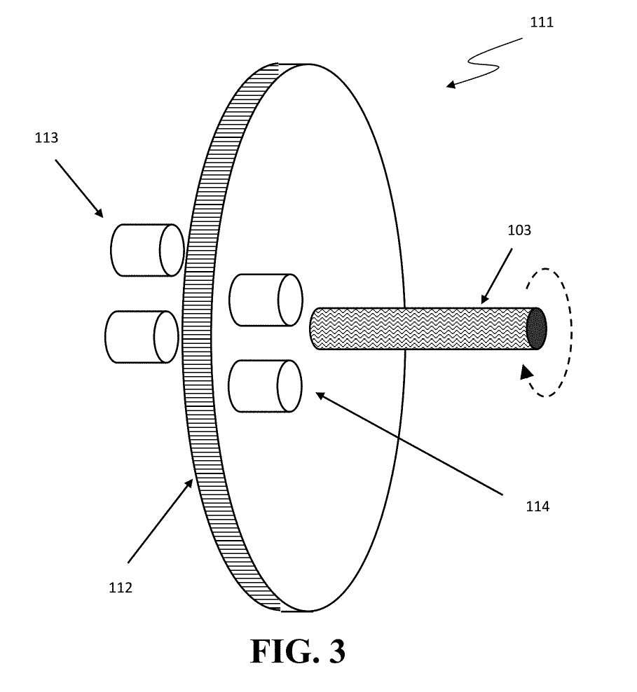

Referring now to FIG. 3: sectional view of the electric motor of the present invention, a conductive disc 112 attached to the shaft 103 is placed between two sets of electric coils 113 and 114 (only two pairs of coils shown, for the sake of simplicity). The set of coils 113 is shifted geometrically against the set 114 by ½ distance between each coil in the set, whereas distance between coils in the set is equal for all coils, for both sets 113 and 114. The coils in each set are placed along perimeter of the disc 112. The coils generate magnetic field due to alternating electric current passing through the coils. All coils 113 are excited with one current, whereas all coils 114 with another. Those AC currents are shifted by 90 deg. phase. Alternating magnetic field generated by the coils result in Eddy Currents induced within conductive disc 112. Opposing magnetic field generated by Eddy Currents cause mechanical torque applied to disc 112, and therefore to shaft 103. Conductive disc 112 is made of low electrical resistance metal (Copper, Aluminum, etc.) with uniform conductivity across the disk, resulting in constant torque at any angle of rotation under given AC currents within coils 113 and 114. The disk 112 is contactless relative to the coils 113 and 114. Preferred embodiment Eddy Current motor does not generate any conventional noise usually associated with friction. The disc and coils configuration of the preferred embodiment develops sufficient torque, although for those experienced in the art, numerous known configurations of Eddy Current motor design could develop equivalent characteristics.

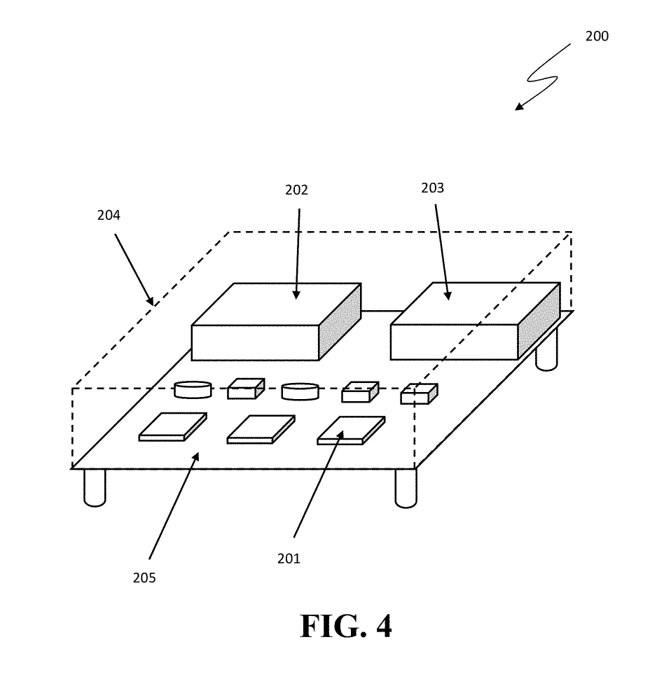

A sectional view of electronics unit of the present embodiment winding apparatus is shown with FIG. 4. Electronic parts 201 are situated with a printed circuit board 205. High power dissipation parts, such as control electronics, are provided with heat sink 202 and 203. The cover 204 houses the unit.

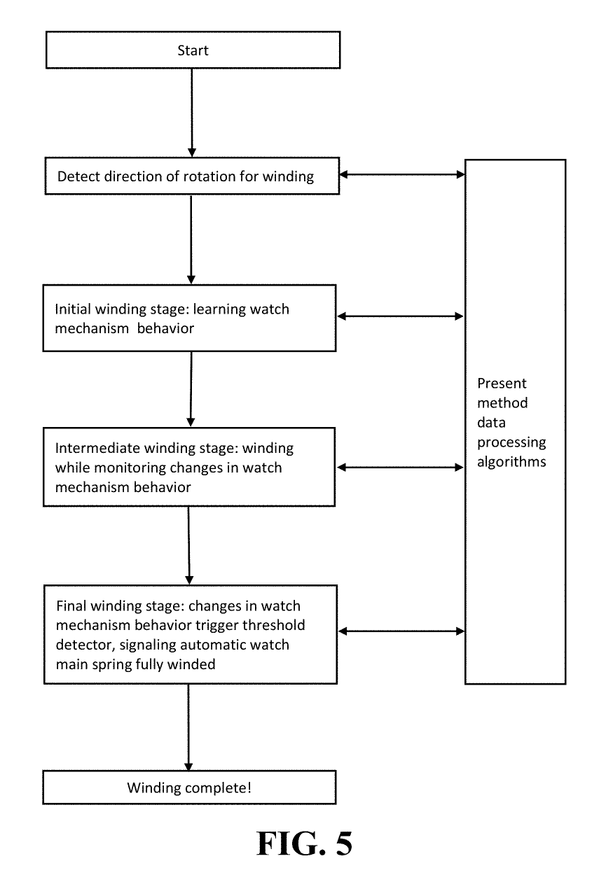

Referring to FIG. 5 a block diagram of operation of the present winding apparatus: the first step in operation is detection correct winding direction. Various designs automatic mechanical watch winding mechanism may need winding in one direction only, as well as allow bidirectional winding. Determination of correct winding direction is performed per below mentioned present invention method. Once correct direction is set, a learning cycle is performed for the purpose of collection statistical data describing behavior automatic mechanical watch at initial stage, assuming winding started with watch main spring winded partially, or not winded at all. Once statistical data are collected, the next step consists of monitoring computed real-time statistics against previously accumulated data. The computation is performed by present method data processing algorithms detailed below. Upon reaching fully winded condition, the above mentioned small feedback pulses cause variations in rotation speed of the shaft, not present at the previous stage. As a result, numbers computed by present invention data processing algorithms in real-time, become sufficiently different against the same accumulated on the previous stage. As a result, the threshold detector signals to stop winding.

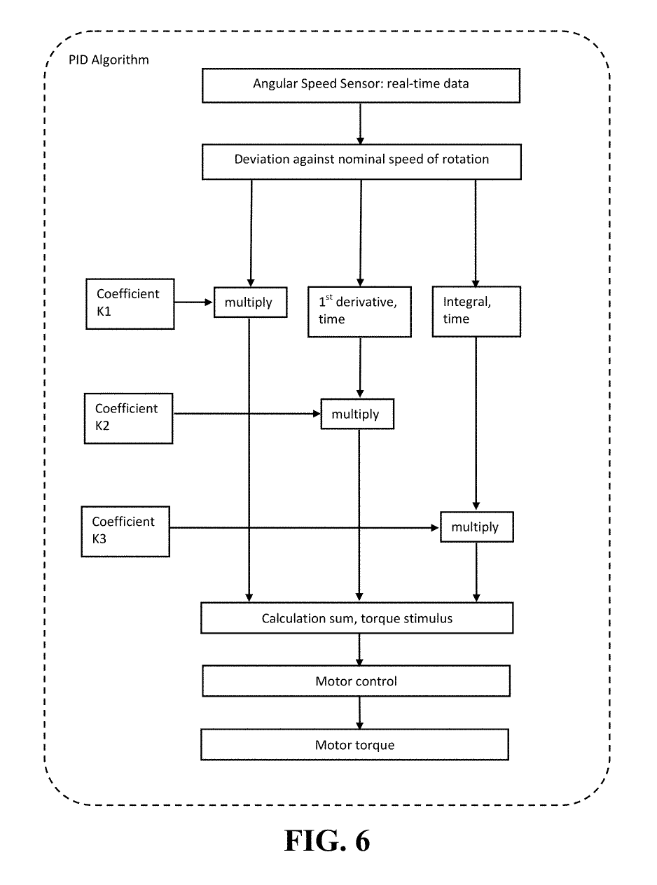

Referring now to FIG. 6 a block diagram of constant winding speed PID algorithm. The need for maintaining constant average rotational speed during whole winding process comes out of the above mentioned underlying idea of the present invention, regarding detection small pulses as mechanical feedback. The pulses impose onto overall rotation of the winding apparatus shaft, result in fast changes of the shaft rotation speed. The present data processing methods employ deviation of the shaft rotation speed against the nominal average speed. Hence maintaining average rotation speed constant is needed for detection the pulses. Alternatively, with the average winding speed unstable and changing, detection of the pulses could be complicated. Numerous efforts were reported on development constant speed algorithms, such as, but not limited to, Proportional Integral Differential (PID) algorithm. The algorithm was adopted within existing method, such as it employs angular speed sensor real-time data. The data are compared against the nominal average winding speed of rotation, and variations are entered into PID algorithm. The entered data are processed with three members of the algorithm: proportional, integral, and differential, then added and scaled, so to form a stimulus for above mentioned Eddy Current motor. The motor develops torque, so to compensate for any change in average winding speed. For example: PID algorithm computes higher stimulus when winding speed starts decreasing, and computes lower stimulus when winding speed increases.

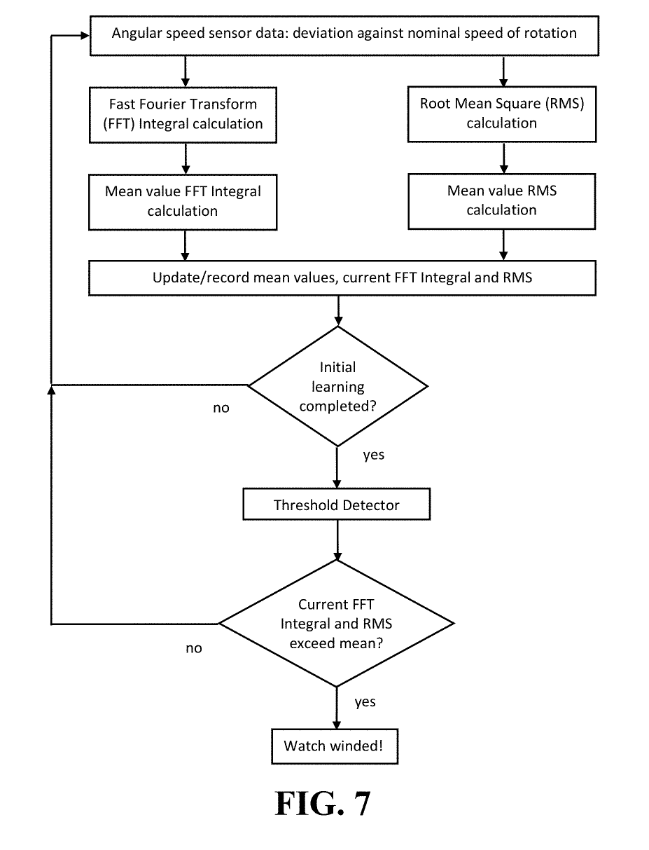

Referring to FIG. 7 block diagram of present invention method for detection watch main spring fully winded state, the above mentioned small deviations in winding speed are processed by microcomputer for the purpose of detection watch main spring winding state. As shown below, change in behavior watch main spring during winding results in change for statistics and corresponding numbers for processed data. Present embodiment of the method employs computation of Fast Fourier Transform (FFT) Integral and root mean square (RMS), although it is clear for those skilled in the art, that other statistical methods could be employed with equivalent results. Assuming winding process started with stopped or partially winded automatic mechanical watch, computation during initial learning stage of the winding process results in data characteristic for main spring initial or partial winded state. Upon developing fully winded state, the above mentioned small feedback pulses are detected by angular speed sensor. In-turn, that results in change of numbers for FFT Integral and RMS computation. A Threshold Detector responds to the change, indicating completely winded state of the spring.

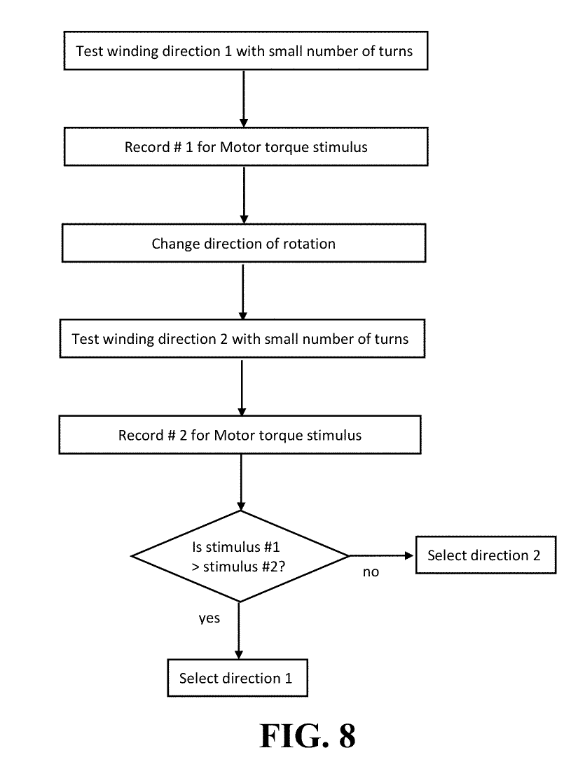

Referring now to FIG. 8: block diagram of the present method for determination watch direction of rotation, comparison of above mentioned Eddy Current motor stimulus for two different winding directions selects the correct one. The present invention method considers that partially winded automatic mechanical watch consumes prevailing amount of motor torque when winding direction results in main spring winded, as opposed to the other direction which does not result in winding main spring, for the case of unidirectional winded watch. For the case of bidirectional winded watch: both directions result in the same torque. Due to direct proportion between motor torque and computed stimulus, comparison of the two numbers allows present invention method to select correct winding direction.

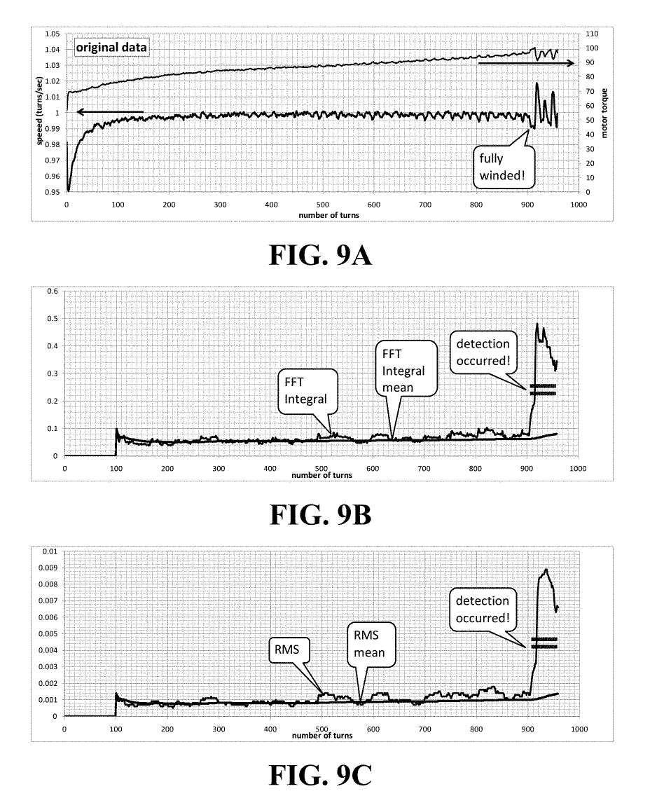

Referring now to FIG. 9: present winding apparatus typical results of operation. The graphs (C), (B), and (C) illustrate automatic mechanical watch full winding process with existing apparatus and method. For this particular illustration, the winding process required about 900 turns.

The graph (A) illustrates typical raw data for automatic mechanical watch: above mentioned Eddy Current motor computed torque stimulus (top curve), and winding rotational speed (bottom curve). As a result of present method computations, the average winding speed is fixated. Numerical value for the speed is 1 turn per second, although for those experienced in the art is clear: the value could be chosen different. Detailed consideration of winding speed curve reveals change in behavior at the last stage of winding: small pulsations in winding rotational speed sharply increased. This illustrates the above mentioned underlying idea of the current invention: watch main spring protection mechanism goes into action for fully winded main spring, which results in feedback pulses. Detailed examination of the motor torque curve reveals gradual increase for its value during winding process, with more torque needed for watch main spring winding as it gets close to fully winded state. For those experienced in the art, the gradual increase of the motor torque data could also allow detection main spring winded state, for estimation number of turns needed for complete winding of any automatic mechanical watch, when stopped watch isn't allowed. That estimation could be used for establishing periodicity and optimal winding schedule to keep watch running for periods of no use and avoid mechanical wear and tear at the same time. The optimal winding schedule may consist of periodic winding to partially winded state of the main spring. Number of turns needed for that partial winding could be based on above mentioned estimation.

The graph (B) illustrates result of computation, according to present method per Fast Fourier Transform (FFT) Integral, with deviations in winding speed against its nominal value as input to FFT. Also shown average (mean) value for FFT Integral.

The graph (C) illustrates result of computation according to present method per Root Mean Square (RMS) deviations in winding speed against its nominal value, as input to RMS. Also shown average (mean) value for RMS.

Upon reaching watch main spring fully winded state at about 900 turns, real-time FFT Integral and RMS exceeded their mean values, which resulted in triggering Threshold Detector (also shown with FIG. 7), indicating end of winding. The Detector reacts only if condition is met for both FFT Integral and RMS.

Both FFT Integral and RMS are known computational algorithms, employed by current method, and adopted by programming with microcomputer 110 (FIG. 2), although for those familiar with the art, other algorithms could be employed as an alternative, with similar results.

This discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A watch winder apparatus comprising:
a shaft configured to carry an automatic watch;
an angular speed sensor;
a drive motor, wherein the angular speed sensor is mounted on the shaft for determination of winding speed rotation and small deviations of the same, and wherein the drive motor is configured to rotate the shaft and wind the attached watch;
electronic circuits that interface with the angular speed sensor, a microcomputer interface, and a motor control; and
a microcomputer configured to display the microcomputer user interface, to receive data from the angular speed sensor, and to compute a control signal for transmission to the electric motor.

2. The apparatus of claim 1, wherein the drive motor comprises a contactless, zero noise electric motor.

3. A method for winding automatic mechanical watch, comprising:
using an angular speed sensor to maintain constant average speed of rotation during a winding process and to acquire small variations of rotation speed;
maintaining a constant average speed of rotation using a constant speed algorithm, which calculates a stimulus current needed for generating torque by an electric motor;
determining a direction of rotation for winding with analysis of the said stimulus;
using small variations in rotation speed as input to detection of the automatic mechanical watch main spring winding state calculation method; and
using computational statistical analysis methods of the small variations for detection of an automatic mechanical watch main spring winding state.
